(19) United States
(12) Patent Application Publication
(10) Pub. No.: US 2023/0132502 A1
(43) Pub. Date: May 4, 2023

(54) ATOMIZER WITH MULTIPLE PRESSURE SWIRL NOZZLES

(71) Applicant: Faurecia Emissions Control Technologies, USA, LLC, Columbus, IN (US)

(72) Inventors: Pankaj KALAN, Columbus, IN (US); Shashidhara RAJASHEKHARAIAH, Columbus, IN (US)

(21) Appl. No.: 17/513,972

(22) Filed: Oct. 29, 2021

(51) Int. Cl. F01N 3/20; B05B 1/34

(52) U.S. Cl. CPC F01N 3/2066; B05B 1/3426; F01N 2610/1453

(57) ABSTRACT

An aftertreatment atomizer, according to an exemplary aspect of the present disclosure includes, among other things, a valve body providing a valve seat and including a plurality of feeding channels, a pintle configured to move between open and closed positions relative to the valve seat, and a nozzle plate including a plurality of swirling grooves Each swirling groove has a pressure swirl nozzle opening configured to eject fluid exiting a respective feeding channel into an exhaust pipe.

### TECHNICAL FIELD

This disclosure relates generally to an atomizer with multiple swirl nozzles for a vehicle exhaust system.

### BACKGROUND

An exhaust system includes catalyst components to reduce emissions. The exhaust system includes an injection system that injects a diesel exhaust fluid (DEF), or a reducing agent such as a solution of urea and water for example, upstream of an exhaust gas aftertreatment component, such as, for example, a selective catalytic reduction (SCR) catalyst which is used to reduce NOx emissions. The injection system includes an atomizer or a doser that sprays the fluid into the exhaust stream via an injector or doser. Low temperature and low load conditions make it difficult to achieve optimum spray characteristics.

### SUMMARY

An aftertreatment atomizer, according to an exemplary aspect of the present disclosure includes, among other things, a valve body providing a valve seat and including a plurality of feeding channels, a pintle configured to move between open and closed positions relative to the valve seat, and a nozzle plate including a plurality of swirling grooves Each swirling groove has a pressure swirl nozzle opening configured to eject fluid exiting a respective feeding channel into an exhaust pipe.

In a further non-limiting embodiment of the foregoing atomizer, the pintle defines a center axis, and wherein the valve body includes a main feeding hole that is concentric with the center axis.

In a further non-limiting embodiment of any of the foregoing atomizers, the main feeding hole is separate from the plurality of feeding channels.

In a further non-limiting embodiment of any of the foregoing atomizers, the valve seat has a tapered surface that tapers radially inwardly in a direction toward the main feeding hole, and wherein each feeding channel has an inlet at the tapered surface and an outlet to one swirling groove of the plurality of swirling grooves.

In a further non-limiting embodiment of any of the foregoing atomizers, each swirling groove has a first inlet port that receives fluid from the outlet of a respective feeding channel and a second inlet port that receives fluid from the main feeding hole, and wherein fluid from the first and second inlet ports is ejected into the exhaust pipe via a respective pressure swirl nozzle opening.

In a further non-limiting embodiment of any of the foregoing atomizers, the nozzle plate includes a recessed area that receives fluid from the main feeding hole and simultaneously directs fluid into each second inlet port of the plurality of swirling grooves.

In a further non-limiting embodiment of any of the foregoing atomizers, each swirling groove includes an enlarged recess forming a swirl chamber that is at least partially defined by curved wall portions, each enlarged recess being located radially inward of a respective first inlet port and radially outward of a respective second inlet port.

In a further non-limiting embodiment of any of the foregoing atomizers, the first inlet port feeds into a first linear passage portion that is tangential to one curved wall portion, and wherein the second inlet port feeds into a second linear passage portion that is tangential to another curved wall portion opposite the one curved wall portion.

In a further non-limiting embodiment of any of the foregoing atomizers, the plurality of feeding channels comprise four feeding channels, and wherein the plurality of swirling grooves comprises four swirling grooves.

In a further non-limiting embodiment of any of the foregoing atomizers, when in the closed position, the pintle engages the valve seat to block the inlets to the plurality of feeding channels while also blocking the main feeding hole, and when in the open position, the pintle moves out of engagement with the valve seat to open the inlets to the plurality of feeding channels while also opening the main feeding hole.

In a further non-limiting embodiment of any of the foregoing atomizers, a heating element heats the fluid before entering the plurality of feeding channels, and including a controller to control the heating element and movement of the pintle.

An aftertreatment atomizer, according to yet another exemplary aspect of the present disclosure includes, among other things, a valve body providing a valve seat and including a plurality of feeding channels, wherein each feeding channel extends from an inlet at the valve seat to an outlet, a main feeding hole formed in the valve body downstream of the valve seat, and a pintle defining a center axis and configured to move between open and closed positions relative to the valve seat. A nozzle plate includes a plurality of swirling grooves, wherein each swirling groove has a pressure swirl nozzle opening for feeding fluid to an exhaust pipe. When the pintle is in the open position, fluid flows into the plurality of feeding channels and the main feeding hole, exits into plurality of swirling grooves, and is then ejected from each pressure swirl nozzle opening into the exhaust pipe.

In a further non-limiting embodiment of any of the foregoing atomizers, the main feeding hole is separate from the plurality of feeding channels which are circumferentially spaced apart from each other about the center axis, and wherein each feeding channel extends from a respective inlet in a radially outward direction to a respective outlet.

In a further non-limiting embodiment of any of the foregoing atomizers, the valve seat has a tapered surface that tapers radially inwardly in a direction toward the main feeding hole, and wherein the inlet of each feeding channel is at the tapered surface and the outlet of each feeding channel is open to one swirling groove of the plurality of swirling grooves.

In a further non-limiting embodiment of any of the foregoing atomizers, each swirling groove has a first inlet port that receives fluid from the outlet of a respective feeding channel and a second inlet port that receives fluid from the main feeding hole, and wherein fluid from the first and second inlet ports is ejected into the exhaust pipe via a respective pressure swirl nozzle opening.

In a further non-limiting embodiment of any of the foregoing atomizers, the nozzle plate includes a recessed area that receives fluid from the main feeding hole and simultaneously directs fluid into each second inlet port of the plurality of swirling grooves, and wherein each swirling groove includes an enlarged recess forming a swirl chamber that is at least partially defined by curved wall portions, each enlarged recess being located radially inward of a respective first inlet port and radially outward of a respective second inlet port.

In a further non-limiting embodiment of any of the foregoing atomizers, the first inlet port feeds into a first linear passage portion that is tangential to one curved wall portion, and wherein the second inlet port feeds into a second linear passage portion that is tangential to another curved wall portion opposite the one curved wall portion.

A method according to still another exemplary aspect of the present disclosure includes, among other things: providing a valve body with a valve seat and a plurality of feeding channels; configuring a pintle to move between open and closed positions relative to the valve seat; positioning a nozzle plate with a plurality of swirling grooves downstream of the pintle; feeding fluid from the plurality of feeding channels into the plurality of swirling grooves when the pintle is in the open position; and ejecting fluid into an exhaust pipe from a pressure swirl nozzle opening associated with each swirling groove.

In a further non-limiting embodiment of the foregoing method, the method further includes: providing a main feeding hole that is downstream of the valve seat and concentric with a center axis defined by the pintle, wherein the main feeding hole is separate from the plurality of feeding channels; tapering the valve seat radially inwardly in a direction toward an upstream end of the main feeding hole; and extending each feeding channel from an inlet at a tapered surface of the valve seat to an outlet to one swirling groove of the plurality of swirling grooves.

In a further non-limiting embodiment of any of the foregoing methods, the method further includes: forming a first inlet port for each swirl chamber of each swirling groove that receives fluid from the outlet of a respective feeding channel; forming a second inlet port for each swirl chamber of each swirling groove that receives fluid from the main feeding hole; forming a recessed area in the nozzle plate that receives fluid from the main feeding hole and simultaneously directs fluid into each second inlet port of the plurality of swirling grooves; and ejecting the fluid received from the first and second inlet ports into the exhaust pipe via the pressure swirl nozzle openings.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 schematically illustrates one example of an exhaust system with an injection system according to the subject disclosure.

FIG. 2 is a section view of one example of an atomizer as used in the injection system of FIG. 1.

FIG. 3 is a perspective view of an upstream side of a nozzle plate from the atomizer of FIG. 2.

FIG. 4 is a view similar to FIG. 3 but showing spray patterns for the nozzle plate.

### DETAILED DESCRIPTION

This disclosure relates generally to fluid atomizers, and more specifically to a dosing module that sprays reductant into an exhaust gas flow path of a vehicle exhaust gas aftertreatment system upstream of an aftertreatment catalyst component. This disclosure details an exemplary atomizer with multiple pressure swirl nozzles that achieve a very small spray droplet size while also increasing the total mass flow rate for injection purposes.

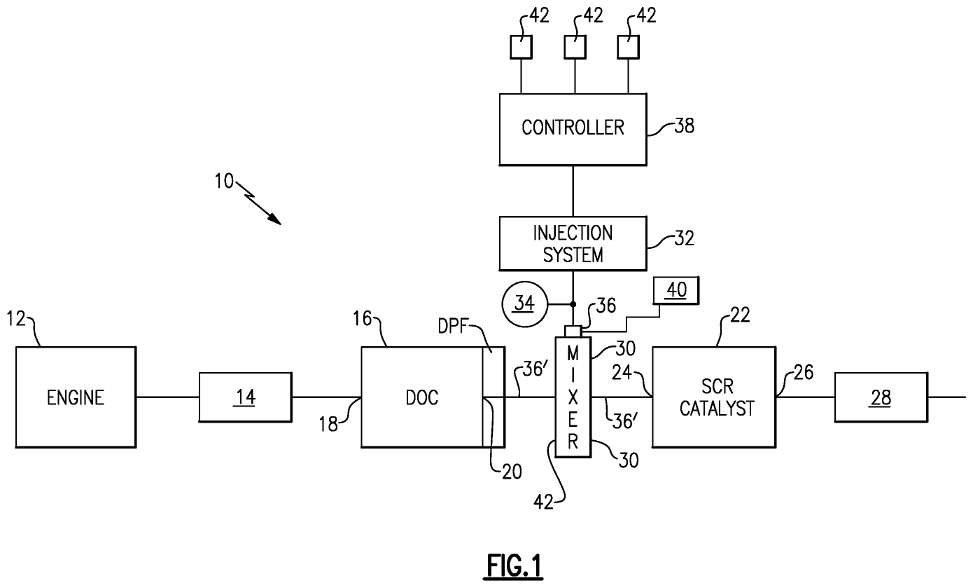

FIG. 1 shows a vehicle exhaust system 10 that conducts hot exhaust gases generated by an engine 12 through various upstream exhaust components 14 to reduce emission and control noise as known. In one example configuration, the upstream exhaust component 14 comprises at least one pipe that directs engine exhaust gases into one or more exhaust gas aftertreatment components. In one example, the exhaust gas aftertreatment components include a diesel oxidation catalyst (DOC) 16 having an inlet 18 and an outlet 20, and an optional diesel particulate filter (DPF) that is used to remove contaminants from the exhaust gas as known. Downstream of the DOC 16 and optional DPF is a selective catalytic reduction (SCR) catalyst 22 having an inlet 24 and an outlet 26. The outlet 26 communicates exhaust gases to downstream exhaust components 28 and then to an external environment. Optionally, component 22 can comprise a catalyst that is configured to perform a selective catalytic reduction function and a particulate filter function. The various downstream exhaust components 28 can include one or more of the following: pipes, filters, valves, catalysts, mufflers etc. These upstream 14 and downstream 28 components can be mounted in various different configurations and combinations dependent upon vehicle application and available packaging space. It should be understood that FIG. 1 is merely one example configuration and that other system architectures and other combinations of exhaust system components could be utilized.

In one example, a mixer 30 is positioned downstream from the outlet 20 of the DOC 16 or DPF and upstream of the inlet 24 of the SCR catalyst 22. The upstream catalyst and downstream catalyst can be in-line or in parallel, for example. The mixer 30 is used to facilitate mixing of the exhaust gas; however, in some configurations a mixer is not utilized.

An injection system 32 is used to inject a reducing agent, such as diesel exhaust fluid (DEF), for example, into the exhaust gas stream upstream from the SCR catalyst 22 such that the mixer 30 can mix the DEF and exhaust gas thoroughly together. Optionally, the injection system 32 can inject the DEF into the exhaust gas stream directly upstream of an exhaust gas after-treatment component, such as the SCR catalyst 22, for example. The injection system 32 includes a fluid supply tank 34, an injector/doser 36, and a controller 38 that controls injection of the fluid as known. In one example, the doser 36 injects the DEF into the mixer 30 as shown in FIG. 1. In other examples, the doser 36 can inject the DEF into the exhaust system at other locations such as upstream or downstream of the mixer 30 as schematically indicated at 36′.

Providing ultra-low NOx emissions requires dosing at low temperatures to address de-nox at cold start and low load cycles. Dosing DEF at low temperatures raises thermolysis and deposit issues as there is usually insufficient heat from the exhaust gas to manage deposits. To address these issues, under certain operating conditions, the injection system 32 heats the DEF prior to entering the exhaust gas stream, which provides for faster atomization and better mixing.

A heating source 40 is associated with the injection system 32 and is used to selectively pre-heat the DEF prior to mixing with exhaust gas. Any type of heating element suitable for heating DEF can be used to provide the heating source 40. For example, the heat source 40 can comprise a heat exchanger assembly with a helical sleeve carrying the DEF, surrounded by heated element on the outside, or electrodes, or other type of heating elements could also be used. Preheating of the DEF occurs in the doser 36 before the DEF is introduced into the exhaust gas stream and the heated DEF can be in the form of a liquid, gas, or a mixture of both. Under certain operating conditions, non-heated DEF is also injected into the exhaust gas stream. The controller 38 is used to control operation of the heating element.

A control system includes the controller 38 that controls heating of the DEF and/or injection of the DEF based on one or more of exhaust gas temperature, exhaust gas flow rate, backpressure, time, wear, etc. Additionally, there are a plurality of sensors 42 that can be used to determine temperatures through the system, flow rates, rate of deposit formation, and wear, for example. The sensors 42 communicate data to the controller 38 such that the controller 38 can determine when to generate a control signal that is communicated to the injection system 32 to control when DEF is to be injected in a heated or non-heated applications.

The controller 38 can be a dedicated electronic control unit or can be an electronic control unit associated with a vehicle system control unit or sub-system control unit. The controller 38 can include a processor, memory, and one or more input and/or output (I/O) device interface(s) that are communicatively coupled via a local interface. The controller 38 may be a hardware device for executing algorithms in software, particularly software stored in memory. The controller 38 can be a custom made or commercially available processor, or generally any device for executing software instructions.

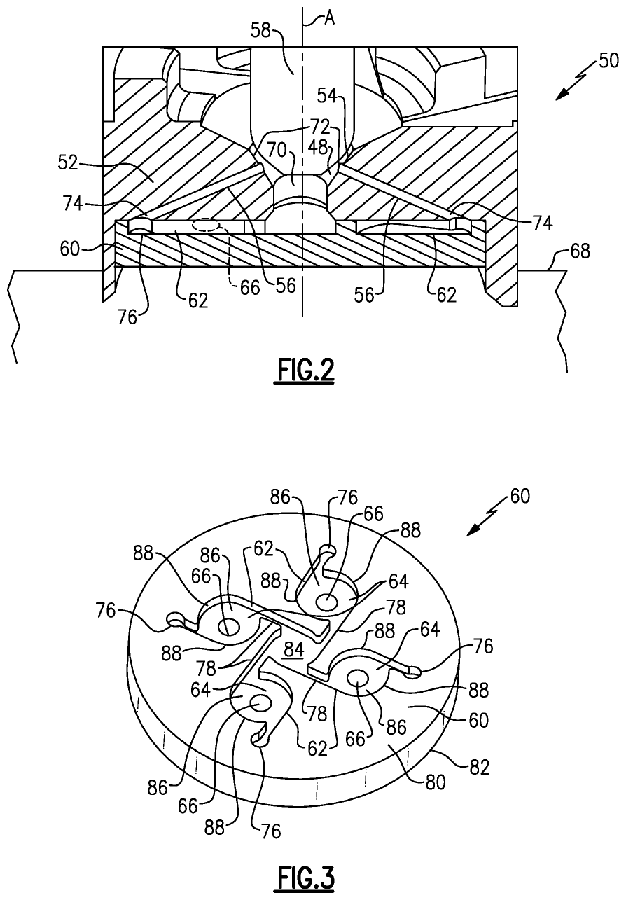

FIG. 2 schematically shows one example of an atomizer 50 for the injector/doser 36 of the injection system 32. In one example, the atomizer 50 includes a pintle seat/valve body 52 having a valve seat 54 and including a plurality of feeding channels 56. A pintle 58 is configured to move within a fluid chamber 48 formed within the valve body 52 between open and closed positions relative to the valve seat 54. Any type of actuator for a dosing system can be used to control movement of the pintle 58. For example, electric actuators or electromagnetic actuators in combination with compression springs could be used to control movement of the pintle. Additionally, the controller 38, for example, can also be used in conjunction with the actuator to control pintle movement.

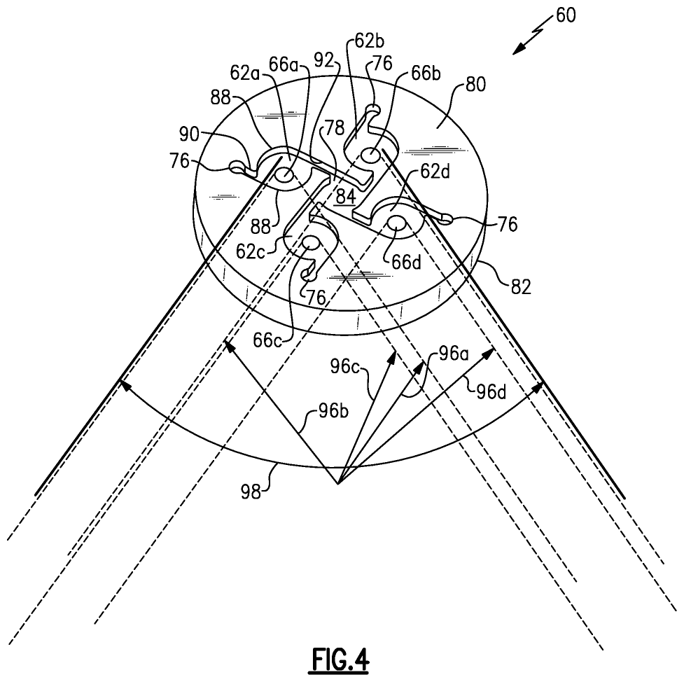

A nozzle plate 60 is directly fixed to the valve body 52 and is positioned downstream of the pintle 58. The nozzle plate 60 includes a plurality of swirling grooves 62. Each swirling groove 62 comprises a swirl chamber 64 and has a pressure swirl nozzle opening 66 (FIG. 3) for feeding fluid to an exhaust pipe 68. Optionally, the fluid can be fed into the mixer 30. The fluid chamber 48 that receives the pintle 58 and the nozzle plate 60 are in fluid communication with each other via the plurality of feeding channels 56 such that the plurality of feeding channels 56 direct the fluid into the plurality of swirling grooves 62 where the fluid is then ejected from the pressure swirl nozzle openings 66 into the exhaust pipe 68.

The pintle 58 defines a center axis A. In one example, the valve body 52 includes a main feeding channel or hole 70 that is concentric with the center axis A. The main feeding hole 70 is separate from the plurality of feeding channels 56 and is downstream of the pintle 58 and the valve seat 54. The main feeding hole 70 receives fluid from the fluid chamber 48 when the pintle 58 is in the open position. The plurality of feeding channels 56 are circumferentially spaced apart from each other about the center axis A, and each feeding channel 56 extends from a respective inlet 72 in a radially outward direction to a respective outlet 74. In one example, the channels 56 extend at an obtuse angle relative to the center axis A.

In one example, the valve seat 54 has a tapered surface that tapers radially inwardly in a direction toward the main feeding hole 70. In one example, the main feeding hole 70 comprises a bore that transitions from a downstream end of the tapered surface of the valve seat 54 and terminates at distal end that is open to the nozzle plate 60. In one example, the bore has a constant diameter. Each feeding channel 56 has an inlet 72 at the tapered surface of the valve seat 54 and an outlet 74 to one swirling groove 62. In one example, each swirling groove 62 has a first inlet port 76 that receives fluid from the outlet 74 of a respective feeding channel 56 and a second inlet port 78 that receives fluid from the main feeding hole 70. Fluid from the first 76 and second 78 inlet ports is ejected as spray into the exhaust pipe 68 via the pressure swirl nozzle openings 66 as shown in FIG. 4.

In one example, the nozzle plate 60 includes an upstream surface 80 facing the pintle 58 and a downstream surface 82 facing opposite the upstream surface 80. A thickness of the plate 60 is defined as the distance between the upstream surface 80 and the downstream surface 82. In one example, the swirling grooves 62 are formed within the upstream surface 80 of the nozzle plate 60. The grooves 62 form discrete recessed swirl areas that do not extend through the entirety of the thickness of the plate 60. Each discrete recessed swirl area includes one pressure swirl nozzle opening 66 that does extend through the entirety of the thickness of the plate 60.

In one example, the nozzle plate 60 includes a recessed area 84 that receives fluid from the main feeding hole 70 and simultaneously directs fluid into each second inlet port 78 of the swirling grooves 62. In one example, the recessed area 84 is formed in the upstream surface 80 of the plate 60 and does not extend through the entire thickness of the plate 60. In one example, the recessed area 84 is centrally located on the nozzle plate 60 and is directly aligned with the main feeding hole 70 along the center axis A.

In one example, each swirling groove 62 includes a discrete enlarged recess 86 that forms the swirl chamber 64 and is at least partially defined by curved wall portions 88. Each enlarged recess 86 is formed in the upstream surface 80 of the nozzle plate 60 and is located radially inward of a respective first inlet port 76 and radially outward of a respective second inlet port 78. The enlarged recesses 86 do not extend through an entirety of the thickness of the plate 60. Additionally, these enlarged recesses 86 are separate from each other and are circumferentially spaced apart from each other about the axis A.

In one example shown best in FIG. 4, the first inlet port 76 feeds into a first linear passage portion 90 that is tangential to one curved wall portion 88, and wherein the second inlet port 78 feeds into a second linear passage portion 92 that is tangential to another curved wall portion 88 opposite the one curved wall portion 88. This is best shown in FIGS. 3-4.

As discussed above, the system includes a heating element from a heat source 40. The heating element is configured to heat the fluid before entering the plurality of feeding channels 56. The controller 38 controls the heating element and movement of the pintle 58.

In one example, when moved into the closed position, the pintle 58 engages the valve seat 54 to block the inlets 72 to the plurality of feeding channels 56 while also blocking the main feeding hole 70. When the pintle 58 is moved into the open position (FIG. 2), the pintle 58 moves out of engagement with the valve seat 54 to open the inlets 72 to the feeding channels 56 while also opening the main feeding hole 70.

In one example, the plurality of feeding channels 56 comprise four feeding channels 56 that feed respectively into four swirling grooves 62a, 62b, 62c, 62d. This is best shown in FIG. 4. Each swirling groove 62a, 62b, 62c, 62d has a respective pressure swirl nozzle opening 66a, 66b, 66c, 66d at a different location on the nozzle plate 60. This generates four smaller spray cones 96a, 96b, 96c, 96d, each being associated with one pressure swirl nozzle opening 66a, 66b, 66c, 66d. The four smaller cones have sprays with smaller droplet size and a reduced mass flow rate compared to the use of one spray cone from a single larger nozzle opening. As shown in FIG. 4, the four spray cones 96a, 96b, 96c, 96d are very close to each other and overlap with each other to form a single combined cone 98 with small droplet size but high mass flow rate. Thus, the subject disclosure provides an atomizer that can achieve a very small spray droplet size while also providing for an increase in the total mass flow rate for fluid injection in a heated doser.

This result is achieved due to the use of four separate pressure swirl nozzles that are all connected to, and controlled by, a single pintle. The droplet size and the mass flow rate of the pressure swirl atomizer decreases with the reduction in its nozzle diameter. Thus, having four pressure swirl atomizers instead of one allows the nozzle diameter to be reduced, thereby reducing the Sauter Mean Diameter (SMD); however, the mass flow rate is not decreased.

For a pressure swirl atomizer (PSA), the SMD of the spray droplets is dependent on the film thickness inside nozzle throat as per the following empirical relationship (Wang and Lefebvre):

$$SMD = 0.08 \frac{{( t cos \frac{θ}{2} )}^{0.25}}{Δ {P}_{L}^{0.5}} + 1.063 \frac{{( t cos \frac{θ}{2} )}^{0.75}}{Δ {P}_{L}^{0.25}}$$

The film thickness is dependent on the nozzle diameter as per following empirical relation:

$$\frac{{( 1 - X )}^{3}}{1 + X} = 0.09 \frac{{A}_{p}}{{D}_{s} {d}_{0}} {( \frac{{D}_{s}}{{d}_{0}} )}^{0.5} , X = \frac{{A}_{air - core}}{{A}_{o}} = \frac{{( {d}_{o} - 2 t )}^{2}}{{d}_{o}^{2}}$$

The mass flow rate is proportional to the flow number, which is dependent on the nozzle diameter:

\dot{m}=FN*\sqrt{(ΔPρ)},FN∝dₒ²

Thus, there are two relations for nozzle diameter:

SMD∝(dₒ)ⁿ and \dot{m}∝dₒ²

By having four smaller PSA, for example, each PSA sprays with smaller droplet size and reduced mass flow rate. This generates four spray cones (FIG. 4) which are very close to each other and overlap to form a single cone with small droplet size but high mass flow rate.

Because the four holes are at different orientations, the axisymmetric uniformity of the cumulative spray can also be expected to be better than a single spray with two inlet ports, for example. Although four holes are shown as an example, fewer holes or additional holes could also be utilized. For example, three and five hole configurations could also be used.

Although a specific component relationship is illustrated in the figures of this disclosure, the illustrations are not intended to limit this disclosure. In other words, the placement and orientation of the various components shown could vary within the scope of this disclosure. In addition, the various figures accompanying this disclosure are not necessarily to scale, and some features may be exaggerated or minimized to show certain details of a particular component.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

1. An aftertreatment atomizer, comprising:
a valve body providing a valve seat and including a plurality of feeding channels formed within the valve body;
a pintle configured to move between open and closed positions relative to the valve seat; and
a nozzle plate including a plurality of swirling grooves, wherein each swirling groove has a pressure swirl nozzle opening configured to eject fluid exiting a respective feeding channel into an exhaust pipe.

2. The aftertreatment atomizer according to claim 1, wherein the pintle defines a center axis, and wherein the valve body includes a main feeding hole that is concentric with the center axis.

3. The aftertreatment atomizer according to claim 2, wherein the main feeding hole is separate from the plurality of feeding channels.

4. The aftertreatment atomizer according to claim 3, wherein the valve seat has a tapered surface that tapers radially inwardly in a direction toward the main feeding hole, and wherein each feeding channel has an inlet at the tapered surface and an outlet to one swirling groove of the plurality of swirling grooves.

5. The aftertreatment atomizer according to claim 4, wherein each swirling groove has a first inlet port that receives fluid from the outlet of a respective feeding channel and a second inlet port that receives fluid from the main feeding hole, and wherein fluid from the first and second inlet ports is ejected into the exhaust pipe via a respective pressure swirl nozzle opening.

6. The aftertreatment atomizer according to claim 5, wherein the nozzle plate includes a recessed area that receives fluid from the main feeding hole and simultaneously directs fluid into each second inlet port of the plurality of swirling grooves.

7. The aftertreatment atomizer according to claim 5, wherein each swirling groove includes an enlarged recess forming a swirl chamber that is at least partially defined by curved wall portions, each enlarged recess being located radially inward of a respective first inlet port and radially outward of a respective second inlet port.

8. The aftertreatment atomizer according to claim 7, wherein the first inlet port feeds into a first linear passage portion that is tangential to one curved wall portion, and wherein the second inlet port feeds into a second linear passage portion that is tangential to another curved wall portion opposite the one curved wall portion.

9. The aftertreatment atomizer according to claim 5, wherein the plurality of feeding channels comprise four feeding channels, and wherein the plurality of swirling grooves comprises four swirling grooves.

10. The aftertreatment atomizer according to claim 4, wherein
when in the closed position, the pintle engages the valve seat to block the inlets to the plurality of feeding channels while also blocking the main feeding hole, and
when in the open position, the pintle moves out of engagement with the valve seat to open the inlets to the plurality of feeding channels while also opening the main feeding hole.

11. The aftertreatment atomizer according to claim 1, including a heating element to heat the fluid before entering the plurality of feeding channels, and including a controller to control the heating element and movement of the pintle.

12. An aftertreatment atomizer, comprising:
a valve body providing a valve seat and including a plurality of feeding channels formed within the valve body, wherein each feeding channel extends from an inlet at the valve seat to an outlet;
a main feeding hole formed in the valve body downstream of the valve seat;
a pintle defining a center axis and configured to move between open and closed positions relative to the valve seat; and
a nozzle plate including a plurality of swirling grooves, wherein each swirling groove has a pressure swirl nozzle opening for feeding fluid to an exhaust pipe, and wherein, when the pintle is in the open position, fluid flows into the plurality of feeding channels and the main feeding hole, exits into plurality of swirling grooves, and is then ejected from each pressure swirl nozzle opening into the exhaust pipe.

13. The aftertreatment atomizer according to claim 12, wherein the main feeding hole is separate from the plurality of feeding channels which are circumferentially spaced apart from each other about the center axis, and wherein each feeding channel extends from a respective inlet in a radially outward direction to a respective outlet.

14. The aftertreatment atomizer according to claim 12, wherein the valve seat has a tapered surface that tapers radially inwardly in a direction toward the main feeding hole, and wherein the inlet of each feeding channel is at the tapered surface and the outlet of each feeding channel is open to one swirling groove of the plurality of swirling grooves.

15. The aftertreatment atomizer according to claim 14, wherein each swirling groove has a first inlet port that receives fluid from the outlet of a respective feeding channel and a second inlet port that receives fluid from the main feeding hole, and wherein fluid from the first and second inlet ports is ejected into the exhaust pipe via a respective pressure swirl nozzle opening.

16. The aftertreatment atomizer according to claim 15, wherein the nozzle plate includes a recessed area that receives fluid from the main feeding hole and simultaneously directs fluid into each second inlet port of the plurality of swirling grooves, and wherein each swirling groove includes an enlarged recess forming a swirl chamber that is at least partially defined by curved wall portions, each enlarged recess being located radially inward of a respective first inlet port and radially outward of a respective second inlet port.

17. The aftertreatment atomizer according to claim 16, wherein the first inlet port feeds into a first linear passage portion that is tangential to one curved wall portion, and wherein the second inlet port feeds into a second linear passage portion that is tangential to another curved wall portion opposite the one curved wall portion.

18. A method comprising:
providing a valve body with a valve seat and a plurality of feeding channels formed within the valve body;
configuring a pintle to move between open and closed positions relative to the valve seat;
positioning a nozzle plate with a plurality of swirling grooves downstream of the pintle;
feeding fluid from the plurality of feeding channels into the plurality of swirling grooves when the pintle is in the open position; and
ejecting fluid into an exhaust pipe from a pressure swirl nozzle opening associated with each swirling groove.

19. The method according to claim 18, including
providing a main feeding hole that is downstream of the valve seat and concentric with a center axis defined by the pintle, wherein the main feeding hole is separate from the plurality of feeding channels,
tapering the valve seat radially inwardly in a direction toward an upstream end of the main feeding hole, and
extending each feeding channel from an inlet at a tapered surface of the valve seat to an outlet to one swirling groove of the plurality of swirling grooves.

20. The method according to claim 19, including
forming a first inlet port for each swirl chamber of each swirling groove that receives fluid from the outlet of a respective feeding channel,
forming a second inlet port for each swirl chamber of each swirling groove that receives fluid from the main feeding hole,
forming a recessed area in the nozzle plate that receives fluid from the main feeding hole and simultaneously directs fluid into each second inlet port of the plurality of swirling grooves, and
ejecting the fluid received from the first and second inlet ports into the exhaust pipe via the pressure swirl nozzle openings.

21. The method according to claim 18, including positioning the pintle within a fluid chamber such that the fluid chamber and the nozzle plate are in fluid communication with each other via the plurality of feeding channels, and including forming each feeding channel to have an inlet at the fluid chamber and an outlet associated with one of the plurality of swirling grooves.

22. The aftertreatment atomizer according to claim 12, wherein the pintle is received within a fluid chamber and wherein the fluid chamber and the nozzle plate are in fluid communication with each other via the plurality of feeding channels, and wherein the outlet of each feeding channel is associated with one of the plurality of swirling grooves.

23. The aftertreatment atomizer according to claim 1, wherein the pintle is received within a fluid chamber and wherein the fluid chamber and the nozzle plate are in fluid communication with each other via the plurality of feeding channels.

24. The aftertreatment atomizer according to claim 23, wherein each feeding channel has an inlet at the fluid chamber and an outlet associated with one of the plurality of swirling grooves.
